(19) United States
(12) Patent Application Publication
(10) Pub. No.: US 2009/0233040 A1
(43) Pub. Date: Sep. 17, 2009

(54) Fire-Resistant Carpet for Aircraft Interiors

(75) Inventors: Hanspeter Baumgartner, Luzern (CH); Paul Scheidegger, Langenthal (CH)

Correspondence Address: BIRCH STEWART KOLASCH & BIRCH, PO BOX 747, FALLS CHURCH, VA, 22040-0747, US

(73) Assignee: LANTAL TEXTILES, Langenthal (CH)

(21) Appl. No.: 12/083,245

(22) PCT Filed: Mar. 29, 2007
(86) PCT No.: PCT/CH2007/000164

§ 371 Date: Sep. 15, 2008

(30) Foreign Application Priority Data
Apr. 4, 2006 (EP) 06405141.0

(51) Int. Cl. B32B 5/26; B32B 37/12; D06N 7/00; A47G 27/02

(52) U.S. Cl. 428/95; 156/60

(57) ABSTRACT

The invention relates to a fire-resistant carpet for aircraft interiors, comprising a machine-woven material, forming a working surface, made from a main yarn, essentially of a fire-resistant thermoplastic synthetic fibre material and an active yarn, essentially of a fire-resistant thermoplastic synthetic fibre material, further comprising a non-woven material, in particular, a needled non-woven material, with a specific weight per area of a maximum of 300 g/m², preferably a maximum of 250 g/m², essentially made from a fire-resistant thermoplastic synthetic fibre material and an intermediate layer containing adhesive between the non-woven material and the flat material with a specific weight per area of a maximum of 250 g/m², preferably a maximum of 200 g/m², in particular 80 g/m², and particularly preferred, a maximum of 50 g/m². The material is a flat material with a specific weight per area of a maximum of 700 g/m², preferably a maximum of 550 g/m² and the specific weight per area of the carpet is a maximum of 1100 g/m², preferably a maximum of 1000 g/m², in particular, a maximum of 900 g/m². According to the invention, the specific combination of a flat material and a non-woven material with the given specific weight per surface area may be used for production of a light carpet, which meets the mechanical requirements of a floor covering which is suitable for the interior of an aircraft and also meets the current standards for flame-resistance and smoke and toxic gas generation.

### FIELD OF THE INVENTION

The invention relates to a low-flammability carpet for aircraft interiors, comprising a machine-woven fabric which forms a traffic surface and is constructed from a base yarn substantially comprising a low-flammability thermoplastic synthetic fiber material, and also an active yarn substantially comprising a low-flammability thermoplastic synthetic fiber material. The invention further relates to a method of laying a low-flammability carpet in aircraft interiors.

### BACKGROUND ART

Carpets, in other words textile fabrics which are composed of a base fabric and of an active layer that primarily forms the traffic surface, and which are employed predominantly as a floorcovering, form part of the typical interior fitments of aircraft. As well as the floor, areas of the internal walls of aircraft as well, more particularly, are often provided with carpets. Carpets in aircraft are subject to particularly stringent requirements: more particularly they are required to exhibit high flame retardance, and the generation of smoke and toxic gases in the event of fire must not exceed strict limits. Corresponding standards are typically prescribed by statute; i.e., more particularly, in passenger aircraft, the only carpets that may be used are those which also meet the standards—for example, standard ABD 0031 on the generation of smoke and toxic gases, and standard FAR 25.853 on the flammability.

From the prior art there are various known carpets for use in an aircraft interior. Pile carpets made from woolen yarns have been dominant to date, though for some time now synthetic carpets have also been developed. Thus, for example, U.S. Pat. No. 4,435,459 (Dow Chemical Co.) discloses a low-flammability carpet having a textile backing through which a yarn is woven or tufted and is subsequently fixed with a specific polyurethane composition.

EP 1 548 182 A2 (Uniplas Shiga Corp., Mitsubishi Engineering-Plastics Corp.) describes a low-flammability carpet comprising a nylon staple yarn with a textile backing of polyester fibers, the staple yarn being joined to the backing by means of a latex composition.

In addition to the flame retardance requirements and the requirements concerning behavior in the event of fire, the basis weight is especially important for a carpet used for the interior fitment of aircraft. In view of the extensive areas within a modern passenger aircraft that are provided with carpets, a reduction of just a few percent in basis weight leads to considerable savings on fuel and hence in costs.

EP 0 600 171 B1 (Hoechst AG) proposes the production of a low-flammability carpet of low basis weight, which is formed from a carrier material of normal-flammability or low-flammability synthetic fibers, a pile yarn incorporated therein and composed of low-flammability synthetic fibers (e.g., Trevira® CS), and a backing finish comprising a specific polyurethane. The weight fractions of pile material, carrier, and finish are approximately 700 to 1300 g/m² pile material, 80 to 250 g/m² carrier, and 150 to 500 g/m², preferably 200 to 300 g/m², polyurethane finish. Disclosed specifically is a tufted carpet consisting of a spunbonded fabric which is consolidated by needling and is composed of unmodified polyethylene terephthalate filaments, this carpet having a pile yarn of low-flammability polyethylene terephthalate needled into it, and comprising a polyurethane back coating. Also specifically disclosed is a stiffened textile fabric made from unmodified polyethylene terephthalate yarn in cross twill weave which is suitable for the production of slats for horizontal and verticle blinds. For the purpose of stiffening, the textile fabric is soaked in a polyurethane dispersion, then squeezed off to a specific dispersion addon, and, finally, dried.

Carpets used in aircraft are also subject to severe mechanical stress and must therefore be changed regularly. In this context there is on the one hand a desire that the carpets should be durable, so that the intervals between change are as long as possible; on the other hand, the carpets ought to be easy to change. The wool carpets often used in aircraft are typically affixed to the base by means of extensive or local adhesive bonding. In order to simplify the attachment and the changing of the carpet, WO 90/01411 (Orcon Corp.) proposes, as an alternative, an adhesive tape that is suitable for affixing carpets in aircraft.

There continues to be a need to reduce the basis weight of carpets for aircraft interiors. The carpets ought, moreover, to be extremely easy and quick to affix and to change in the aircraft.

### DISCLOSURE OF THE INVENTION

It is an object of the invention, therefore, to provide a carpet of the technical field specified at the outset that has a low basis weight and that preferably is easy and quick to affix in the aircraft.

The achievement of the object is defined by the features of claim 1. In accordance with the invention the machine-woven fabric of the carpet is a flat-woven fabric having a basis weight of not more than 700 g/m², preferably not more than 550 g/m². A flat-woven fabric is distinguished by the fact that it has no pile-forming filament system; accordingly, it is produced on a flat-weaving machine (without pile wires). The carpet further comprises a nonwoven web, more particularly a needle felt web, having a basis weight of not more than 300 g/m², preferably not more than 250 g/m², substantially comprising a low-flammability thermoplastic synthetic fiber material, and also an adhesive-containing interlayer between the web and the flat-woven fabric, having a basis weight of not more than 250 g/m², preferably not more than 200 g/m², more particularly 80 g/m², with particular preference not more than 50 g/m². The basis weights of the individual components of the carpet are chosen such that the basis weight of the carpet is not more than 1100 g/m², preferably not more than 1000 g/m², more particularly not more than 900 g/m².

As a result of the specific inventive combination of a flat-woven fabric with a nonwoven web having the specified basis weights, it is possible to produce a lightweight carpet which meets the mechanical requirements for a floorcovering and which is suitable for an aircraft interior, i.e., which meets the common standards (e.g., ABD 0031) for flame retardance and for the generation of smoke and toxic gases. One of the ways in which this is achieved is through the use, not only for all of the yarn systems but also for the nonwoven web, of a low-flammability thermoplastic synthetic fiber material.

In the course of the development of the carpet of the invention it emerged, surprisingly, that a flat carpet, formed by a flat-woven fabric, an interlayer, and a nonwoven web, can be produced with a lower basis weight than a pile carpet which is comparable in terms of the mechanical properties. Using commercially available yarn material it is possible to produce a flat-woven fabric having the stated basis weight and meeting the requirements imposed on a carpet for an aircraft interior, in interaction with the interlayer and with the web, in terms of mechanical robustness and esthetic impression. The web mounted on the back of the flat-woven fabric, by means of the interlayer, serves for the mechanical reinforcement of the flat-woven fabric, by giving the carpet cut-edge strength and also a high level of dimensional stability; it improves walk comfort in the case of the carpet used as a floor covering in open areas and aisles; and it leads to better noise suppression and hence to improved interior acoustics within the aircraft. Suitable nonwoven webs, more particularly needle felt webs, having a basis weight within the stated range are available commercially.

In addition to the joining function between flat-woven fabric and web, the interlayer also fixes the points of intersection of the flat-woven fabric, thereby further increasing the mechanical stability of said fabric. Moreover, given an appropriate composition, the interlayer may further increase the flame retardance of the carpet.

On account of its low basis weight it is possible, through the use of the carpet of the invention in an aircraft interior, to achieve substantial fuel savings in air operation and hence to save considerable costs. The carpet, moreover, can be produced more cost-effectively as compared with pile carpets of similar quality.

The carpet, produced from a machine-woven, flat-woven fabric which forms the traffic surface and comprises a low-flammability thermoplastic synthetic fiber material, and from a nonwoven web which is joined to the flat-woven fabric via an adhesive-containing interlayer and comprises a low-flammability thermoplastic synthetic fiber material, offers the advantage, furthermore, that it can be affixed in the aircraft interior in a simple way by means of a hook-and-loop tape. To attach the carpet, therefore, hook-and-loop tapes (one side of which is given, for example, a self-adhesive configuration) are affixed at suitable intervals to the areas to be furnished with carpet, and, subsequently, the carpet is mounted on the affixed hook-and-loop tape by its side formed by the web. For the purpose of changing carpet, the carpet can be parted from the hook-and-loop tape, and the new carpet can simply be pressed onto the existing hook-and-loop tape.

The base yarn, the active yarn, and the web are produced advantageously from the same low-flammability thermoplastic synthetic fibre material. With advantage this synthetic material is durably of low flammability; i.e., the material itself has been given a flame-retardant modification and does not just have a corresponding coating. Materials which have proven particularly suitable are those based on polyester. One suitable material, more particularly, is Trevira® CS from Hoechst. This material is based on polyester whose polymer backbone includes an incorporated phosphorus comonomer, endowing the material with permanent low flammability. A flat carpet in which not only the base yarn and the active yarn but also the web are produced from this material meets the abovementioned standards, is mechanically durable even at low weight, and fulfils the esthetic expectations of a carpet for the aircraft interior. The material can be treated for dirt, water, and oil repellence using suitable, commercially available substances.

The flat-woven fabric and the nonwoven web are advantageously joined by lamination. For that purpose, one of the two flat materials is coated on its back with the material for the interlayer. Then, in a laminating station, the second flat material is guided with its back onto the coated side of the first material, whereupon the two materials can be compressed—between two rolls, for example—under pressure and at a defined temperature. Subsequently the materials can be actively cooled.

The adhesive-containing interlayer between the web and the flat-woven fabric is formed advantageously by a composition which comprises the following:
a) an adhesive based on polyacrylate;
b) water;
c) a flame retardant, more particularly based on aluminum hydroxide Al(OH)₃; and
d) surface-active substances.

In experiments it has been found that with an interlayer of this kind it is possible to produce a lightweight and durable flat carpet which meets the relevant standards relating to flammability and also to the generation of smoke and toxic gases. More particularly the surface-active substances also include wetting agents. The interlayer may comprise further—commonplace—substances, more particularly finishing agents for the finishing of the flat-woven fabric.

At the time of application the fraction of the adhesive is preferably 40-70% by weight and the fraction of the water is 20-40% by weight. A composition of this kind permits efficient joining of the flat-woven fabric to the web and is especially suitable for the laminating operation.

To allow a lightweight, durable, and esthetically advantageous carpet to be produced, the ratio between the basis weight of the active yarn fraction and the basis weight of the base yarn fraction of the flat-woven fabric is between 1.0 and 2.5, more particularly between 1.3 and 2.0. On the one hand this has the effect of achieving good stability on the part of the flat-woven fabric; on the other hand, however, the flat carpet also has a “carpetlike” appearance and not merely a “fabriclike”, effect.

Likewise of advantage for the attainment of these objectives is the use of continuous filament yarns for the base yarn and for the active yarn, with the base yarn having a linear density of 400-1300 dtex, more particularly of 600-1000 dtex, and the active yarn a linear density of 2000-6000 dtex, more particularly of 3000-5000 dtex. The base yarn is processed both in a warp thread system and in a weft thread system, while the active yarn is used advantageously only in a warp system. The densities of the individual yarns in the warp system and, where appropriate, in the weft system are chosen in such a way that the basis weights referred to above are achieved.

In order to enhance the electrostatic characteristics of the carpet of the invention, the active yarn has with advantage a fraction of 0.5%-5% by weight, more particularly of 1%-3% by weight, of carbon fibers. These fibers reduce the surface resistance and therefore prevent the formation of electrostatic charges. Such a fraction of carbon fibers does not lead to any significant impairment of the advantageous properties in terms of flame retardance, smoke generation, and toxicity.

Further advantageous embodiments and combinations of features of the invention emerge from the detailed description below and from the entirety of the claims.

### EMBODIMENTS OF THE INVENTION

A carpet of the invention for aircraft interiors is composed generally of at least three layers: a machine-woven fabric, which forms the traffic surface; a nonwoven web; and an interlayer that joins the fabric and the web. Through the selection of the materials used for the individual layers, and through variation of the respective parameters of the layers, it is possible to tailor the properties of the carpet in terms of basis weight, mechanical robustness, step comfort, noise suppression, and esthetics. A number of exemplary embodiments are set out hereinbelow.

### Example 1

In the case of the carpet according to one first exemplary embodiment, the web is laminated onto the back of the flat-woven fabric. The flat-woven fabric is composed of a base yarn and an active yarn, which are both continuous filament yarns produced from the material Trevira® CS from Hoechst. The base yarn has a linear density of 850 dtex, the active yarn an (individual) linear density of 4000 dtex. Besides the Trevira® CS base material, the active yarn includes a fraction of 2% carbon fibers.

The flat-woven fabric is produced on a flat-weaving machine (i.e., a weaving machine without pile wires) having a reed width of 190.4 cm, where a first beam is loaded with 3040 warp threads of the base yarn, while on a second beam there are 768 pairs of twisted-together threads of the active yarn creeled. The warp threads of the base yarn are creeled on four 760-heald frames, those of the active yarn on 12 64-heald frames. The weft, in turn, is formed by the base yarn, with 8 threads woven in per cm.

For the thread density in the warp system the value that results for the base yarn is 16 threads/cm and for the active yarn 4(*2) threads/cm. The basis weight of the base yarn fraction is approximately 204 g/m², that of the active yarn approximately 320 g/m².

The nonwoven web is a flame-retardant conductive needle felt web. It is formed from low-flammability polyester fibers which are produced in turn from the material Trevira® CS from Hoechst. Webs of this kind are available commercially, on rolls up to 4 m in width and 500 m in length. The basis weight of this carrier web is approximately 200 g/m² in accordance with standard EN 965; its thickness is 2.1 mm in accordance with EN 964-1.

From the mechanical standpoint, the carrier web has a breaking load of 5.0 kN/m in longitudinal direction and of 7.0 kN/m in transverse direction (in accordance with standard EN ISO 10319); the tear propagation resistance to DIN 53859 is 70 N. The resistance to ground (at a potential of 100 V) is below 10⁸ MΩ. The web falls within fire class M1 according to the French standard.

In the course of a laminating process, the flat-woven fabric is first coated with a coating composition on its back. For this purpose the fabric can be guided by a roller over a roll on whose top face a blade is disposed at a defined distance. The coating composition is applied to the flat-woven fabric downstream of the blade in the transport direction of the fabric. Subsequently a web of nonwoven matching the width of the flat-woven fabric is guided in parallel with the fabric onto its back. The two textile layers with the coating formula in between are then transported together into a laminating station, where first the material is heated and then the assembly is compressed between two counter-rotating rolls. The coating formula thus forms an interlayer which joins the textile layer. Finally the flat material is passed through a drying tunnel in which solvents present in the interlayer are stripped off, and so the flat carpet is dried and consolidated.

The coating composition is based on a polyester-polyol isocyanurate dispersion. It can be prepared, for example, by mixing 60 kg of Appretan N 5228-1, 35 kg of water, 2.5 kg of Martinal ON 313 (based on Al(OH)₃), 2.6 kg of Genaminox CLS, 0.6 kg of Appretan thickener 3308, and 0.1 kg of wetting agent. For the laminating operation a temperature of 160° C. is chosen and also a pressure at the rolls of approximately 4 tonnes. The condensing time is 4 minutes. The amount of composition applied to the flat-woven fabric is chosen such that, after the carpet has been laminated and dried, the interlayer still has a basis weight of approximately 150 g/m².

A series of tests and measurements were conducted with a carpet produced in this way.

| Test/Parameter | Standard | Result | |
|---|---|---|---|
| Basis weight | ISO 8543 | 875 | g/m² |
| Thickness | DIN EN ISO 1765 | 2.7 | mm |
| Retention of | ISO 10361 | class 4-5 | |
| appearance (Hexapod) | | | |
| Boeing trolley test | BSS 7300 | class 4-5 | |
| Pole strength | LT standard | 19.9 | daN |
| Pilling (Martindale) | DIN EN ISO 12945-2 | class 4 | |
| Vertical flame test | FAR 25.853 | complies | |
| (12 s) | (Appendix F | | |
| | Part I(a)(1)(II)) | | |
| Smoke test (with | ABD 0031 | 118 | Dm (complies) |
| flame) | | | |
| Smoke test (without | ABD 0031 | 15 | Dm (complies) |
| flame) | | | |
| Toxicity | ABD 0031 | complies | |
| (with/without flame) | | | |
| Surface resistance | DIN 54345-1 | <10⁶ | Ω |
| Contact resistance | DIN 54345-1 | 10⁶ | Ω |
| Dimensional | BSS 7310 | +0.04% | |
| stability, warp | | | |
| direction | | | |
| Dimensional | BSS 7310 | +0.14% | |
| stability, weft | | | |
| direction | | | |
| Delamination, warp | ISO 36 | 5.15 | daN |
| direction | | | |
| Delamination, weft | ISO 36 | 4.56 | daN |
| direction | | | |

The carpet, then, has a low basis weight, which is considerably smaller than that of pile carpets typically used at present for aircraft interiors. The wear measurements produced a high durability and hence a long lifetime. The carpet meets the common tests for flammability and flame retardance and also for smoke generation and for the generation of toxic gases under fire exposure. The laminated web helps give the carpet a high dimensional stability. Owing to the carbon fibers in the active yarn fraction and to the correspondingly reduced surface resistance of the carpet, the formation of static charges is prevented.

### Examples 2-4

The table below shows further examples of flat carpets of the invention. As in the case of example 1, the flat-woven fabric and the nonwoven web are produced from Trevira® CS, and the interlayer likewise has the same composition. The production process likewise corresponds to that for the flat carpet of example 1 (with the usual adaptations of the weaving operation for different thread counts):

| Property | Example 2 | Example 3 | Example 4 | Example 5 |
|---|---|---|---|---|
| Linear density, | 600 | 1000 | 850 | 850 |
| base yarn (dtex) | | | | |
| Linear density, | 6000 | 3200 | 7500 | 4000 |
| active yarn (dtex) | | | | |
| Number of warp | 3428 | 2664 | 3040 | 3040 |
| threads, base yarn | | | | |
| Number of warp | 636 | 768 | 1024 | 768 |
| threads, active | | | | |
| yarn | | | | |
| Number of twisted | 2 | 2 | 1 | 2 |
| warp threads, | | | | |
| active yarn | | | | |
| Warp thread count, | 18.0 | 14.0 | 16.0 | 18.0 |
| base yarn, 1/cm | | | | |
| Warp thread count, | 3.3 | 4.0 | 5.4 | 4.0 |
| active yarn, 1/cm | | | | |
| Weft thread count, | 10 | 8 | 8 | 8 |
| base yarn, 1/cm | | | | |
| Basis weight, base | 168 | 220 | 204 | 240 |
| yarn, g/m² | | | | |
| Basis weight, | 401 | 258 | 403 | 380 |
| active yarn, g/m² | | | | |
| Ratio of active/ | 2.39 | 1.17 | 1.98 | 1.58 |
| base yarn basis | | | | |
| weight | | | | |
| Basis weight of | 569 | 478 | 607 | 620 |
| flat-woven fabric | | | | |
| g/m² | | | | |
| Basis weight of | 200 | 150 | 200 | 200 |
| carrier web g/m² | | | | |
| Thickness of | 2.1 | 1.6 | 2.1 | 2.1 |
| carrier web mm | | | | |
| Basis weight of | 150 | 130 | 150 | 40 |
| interlayer (dry) | | | | |
| g/m² | | | | |
| Basis weight, | 919 | 758 | 957 | 860 |
| total g/m² | | | | |

Example 2—as compared with example 1—concerns a carpet having a relatively high weight fraction of the active yarn, more particularly since an active yarn having a substantially greater linear density is used. This allows good mechanical values to be obtained; the carpet is very durable and retains its optical properties for a long time. Because of the larger pattern and because the dense active material means that the base material is no longer visible, however, the resulting design possibilities are fewer than in the case of a carpet according to example 1.

The carpet according to example 3 has a high fraction of base yarn. This, moreover, has a higher linear density than in the case of the preceding examples. With a carpet of this kind, the base yarn also forms part of the traffic surface of the carpet, and is therefore also significant for the carpet's mechanical properties. Generally speaking, a carpet of this kind is not quite as durable as one according to example 1 or 2, in view of the fact that the base yarn as well is visible from the facing side; however, there are diverse design possibilities. Since the base yarn fraction is inherently greater, it is possible to reduce the thickness of the web and hence its basis weight, thereby making it possible overall to manufacture an extremely lightweight carpet.

Example 4 relates to a carpet in which the active yarn is woven individually and not in pairs as in examples 1-3.

Example 5 relates to a carpet having a thin interlayer (adhesive). It has emerged, surprisingly, that even with a low adhesive fraction it is possible to produce carpets which are durable and fulfill all of the requirements.

In summary it is observed that the invention creates a carpet which has a low basis weight and which can be affixed easily and quickly in the aircraft.

1. A low-flammability carpet for aircraft interiors, comprising
a) a machine-woven fabric which forms a traffic surface and is constructed from a base yarn substantially comprising a low-flammability thermoplastic synthetic fiber material and also an active yarn substantially comprising a low-flammability thermoplastic synthetic fiber material;
characterized by
b) a nonwoven web, more particularly a needle felt web, having a basis weight of not more than 300 g/m², preferably not more than 250 g/m², substantially comprising a low-flammability thermoplastic synthetic fiber material; and also
c) an adhesive-containing interlayer between the web and the machine-woven fabric, having a basis weight of not more than 250 g/m², preferably not more than 200 g/m², more particularly 80 g/m², with particular preference not more than 50 g/m²,
where
d) the fabric is a flat-woven fabric having a basis weight of not more than 700 g/m², preferably not more than 550 g/m², and where the carpet has a basis weight of not more than 1100 g/m², preferably not more than 1000 g/m², more particularly not more than 900 g/m².

2. The carpet of claim 1, characterized in that the base yarn, the active yarn, and the web are produced from the same low-flammability thermoplastic synthetic fiber material.

3. The carpet of claim 2, characterized in that the low-flammability thermoplastic synthetic fiber material is a material based on polyester.

4. The carpet of claim 1, characterized in that the flat woven fabric and the web with the interlayer are joined to one another in the course of a laminating operation.

5. The carpet of claim 1, characterized in that the adhesive-containing interlayer between the web and the flat-woven fabric is formed by a composition which comprises the following:
a) an adhesive based on polyacrylate;
b) water;
c) a flame retardant, more particularly based on aluminum hydroxide Al(OH)₃; and
d) surface-active substances.

6. The carpet of claim 5, characterized in that the fraction of the adhesive is 40-70% by weight and the fraction of water is 20-40% by weight.

7. The carpet of claim 1, characterized in that the ratio between a basis weight of an active yarn component and a basis weight of a base yarn component of the flat-woven fabric is between 1.0 and 2.5, more particularly between 1.3 and 2.0.

8. The carpet of claim 1, characterized in that the base yarn is a continuous filament yarn having a linear density of 400-1300 dtex, more particularly of 600-1000 dtex, and in that the active yarn is a continuous filament yarn having a linear density of 2000-6000 dtex, more particularly of 3000-5000 dtex.

9. The carpet of claim 1, characterized in that the active yarn has a fraction of 0.5%-5% by weight, more particularly of 1-3% by weight, of carbon fibers.

10. A method of laying a low-flammability carpet, more particularly a carpet of claim 1, in the interior of aircraft, where the carpet is composed of a machine-woven, flat-woven fabric which forms the traffic surface and comprises a low-flammability thermoplastic synthetic fiber material, and of a nonwoven web which is joined to the flat-woven fabric via an adhesive-containing interlayer and comprises a low-flammability thermoplastic synthetic fiber material, characterized in that a hook-and-loop tape is affixed to areas that are to be furnished with the carpet, and in that subsequently the carpet is mounted by its side formed by the web on the affixed hook-and-loop tape.
